(19) United States
(12) Patent Application Publication
(10) Pub. No.: US 2024/0213854 A1
(43) Pub. Date: Jun. 27, 2024

(54) LIQUID-COOLED AXIAL FLUX MACHINE

(71) Applicant: Baumueller Nuernberg GmbH, Nuernberg (DE)

(72) Inventors: Nathalie ZILLES, Nuernberg (DE); Uwe KOSTKA, Nuernberg (DE)

(73) Assignee: Baumueller Nuernberg GmbH, Nuernberg (DE)

(21) Appl. No.: 18/389,874

(22) Filed: Dec. 20, 2023

(30) Foreign Application Priority Data
Dec. 22, 2022 (DE) 10 2022 214 345.0

(51) Int. Cl. H02K 9/197; H02K 1/20; H02K 21/24

(52) U.S. Cl. CPC H02K 9/197; H02K 1/20; H02K 21/24; B63H 21/17

(57) ABSTRACT

A liquid-cooled axial flux machine with a rotatable rotor and a ring-shaped stator arranged around the axis, which are offset from each other parallel to the axis. The stator is located in a first space of a housing and the rotor in a second space of the housing, which are separated from each other by a separating disc and fluidically separated from each other. Furthermore, a motor vehicle is provided.

This nonprovisional application claims priority under 35 U.S.C. § 119(a) to German Patent Application No. 10 2022 214 345.0, which was filed in Germany on Dec. 22, 2022, and which is herein incorporated by reference.

### BACKGROUND OF THE INVENTION

### Field of the Invention

The present invention relates to a liquid-cooled axial flux machine comprising a rotatable rotor and a ring-shaped stator arranged around the axis, offset from each other parallel to the axis. Furthermore, the invention relates to a motor vehicle.

### Description of the Background Art

Electric machines, i.e., electric motors and generators, usually have a stator and a rotor that can be rotated about an axis, which is supported by bearings, such as roller bearings. Usually, the rotor and stator are arranged in a common housing so that they are protected from foreign particles. Touch protection is also provided in this way.

In principle, it is possible to design the electric machine as a radial flux machine or axial flux machine. In the case of the radial flux machine, the rotor surrounds the stator on the circumferential side or vice versa, so that it is designed either as an internal rotor or an external rotor. The magnetic fields interacting between the rotor and the stator essentially run between them in a radial direction. If a comparatively high torque is to be provided by means of the electric motor, it is necessary to choose a comparatively large distance between the axis and the area of transition between the rotor and the stator. This results in a comparatively large diameter of the electric motor. In the axial flux machine, on the other hand, the rotor and stator are offset from each other along the axis, and the magnetic fields acting between the stator and the rotor essentially run in the axial direction. This makes it possible to design the electric machine with a comparatively small radial expansion.

If high power is to be provided by means of the electric machine, comparatively high currents flowing over the electric machine are required. As a result, the resulting electrical losses are also high, which leads to heating of the electric machine. In order to avoid destroying the electric machine, it is necessary to actively cool it, as it is not sufficient to release the heat only into the ambient air. A cooling liquid, such as oil or water, is usually used for cooling, which is used to remove the excess heat. In the case of an axial flux machine, several cooling channels are usually inserted into the housing through which the coolant is guided.

The disadvantage of this is that the components that are heated due to the electrical losses are not cooled directly, so that direct cooling is not possible in the event of a local overload, and one of the components may be damaged. Thermal coupling between the components and the housing is also required, which limits design freedom. In order for the largest possible volume of coolant to pass through the cooling channels, it is necessary to increase the length of these channels, which makes it difficult to design and create. Also, the processes that can be used to manufacture the housing are limited.

### SUMMARY OF THE INVENTION

It is therefore an object of the present invention to provide a particularly suitable axial flux machine as well as a particularly suitable motor vehicle, wherein manufacture and/or design are advantageously simplified, and wherein an increase in efficiency and/or power is expediently provided.

The axial flux machine is, for example, a generator or, most preferably, an electric motor. In particular, it is possible to operate the axial flux machine both regeneratively and by electric motor, and the axial flux machine is suitable for this purpose, especially designed and equipped. In particular, the axial flux machine has a maximum or nominal power between 100 KW and 500 KW, and preferably 200 kW. Particularly preferably, the axial flux machine has a maximum or nominal torque between 800 Nm and 1800 Nm, between 1000 Nm and 1500 Nm, preferably from 1200 Nm.

For example, the axial flux machine is suitable, especially if it is intended and set up, to be part of a plant, such as an industrial plant. For example, an actuator is operated by means of the axial flux machine, which is used to process and/or create a workpiece. Alternatively or in combination with this, a transport device is operated by means of the axial flux machine.

However, the axial flux machine is particularly preferred as a component of a motor vehicle when it is assembled. The motor vehicle is, for example, land bound and, for example, a commercial vehicle, such as a truck or a bus, an agricultural machine, a construction machine, a snow groomer or a passenger car (automobile). In an alternative to this, the axial flux machine is a component of an airplane or helicopter. However, the axial flux machine is particularly preferred as a component of a ship or boat in its assembly state.

The axial flux machine is particularly preferred as a component of a main drive, by means of which, in particular, the movement of the motor vehicle is created or at least supported. If the axial flux machine is a component of a ship/boat, it is used to drive one or more propellers via a ship shaft. In an alternative to this, the axial flux machine is arranged, for example, in an engine nacelle or the like.

The axial flux machine has a rotor that can be rotated about an axis. Conveniently, the axial flux machine comprises a shaft, which is suitably rotatably mounted and which is arranged concentrically to and on the axis. In particular, the shaft is made of a steel. Conveniently, the rotor is connected to the shaft, like a sheet metal package or at least magnets, especially permanent magnets. Preferably, any permanent magnets are embedded in the sheet metal package or at least held in place by means of it.

The axial flux machine also has a stator, which is ring-shaped, which is arranged around the axis so that the stator surrounds the axis. Appropriately, the ring-shaped stator is arranged concentrically to the axis. Preferably, the stator surrounds the possible shaft on the circumferential side. The stator is suitably equipped with one or more magnets, especially electromagnets. In particular, each electromagnet is formed by means of an electric coil wound onto a core, for example, which is provided by other components of the stator, such as a sheet metal package.

The rotor and stator can be offset from each other parallel to the axis, i.e., in the axial direction. In particular, the magnets of the rotor and the stator can be arranged in such a way that a magnetic field is created essentially parallel to the axis between them during operation. It is particularly preferable that the rotor and the stator are congruent with each other, so that a projection of the rotor onto the stator along the axis or vice versa leads to overlapping. This reduces the need for space.

The axial flux machine can have a housing with a first space and a second space, which are offset parallel to the axis. In other words, the two spaces are axially offset from each other. The stator is located in the first space and the rotor in the second space. The two spaces are delimited by a separating disc, which is arranged in particular perpendicular to the axis. In other words, the separating disc is arranged between the two spaces, and by means of this the two spaces are delimited on the opposite side. In addition, the separating disc is used to separate the two spaces from each other in terms of fluid technology. In other words, the passage of a fluid, or at least a liquid, between the two spaces is prevented by means of the separating disc. In particular, the separating disc prevents the passage of a liquid.

The axial flux machine can be liquid-cooled. In other words, during operation, a coolant is passed through the axial flux machine, which is used to dissipate excess heat. The axial flux machine is suitable for this purpose, especially provided and set up. In summary, the axial flux machine is a liquid-cooled axial flux machine, which will be referred to in the following as an axial flux machine. Preferably, the first space is suitable, in particular provided and set up to be connected to a cooling circuit. Conveniently, a coolant is disposed in the first space during operation, and the first space has in particular means of fluidic coupling with other components of the possible cooling circuit. In summary, the first space is designed in such a way that a coolant is passed through it during operation, by means of which excess heat is removed. Preferably, the axial flux machine is designed in such a way that the stator is at least partially flushed by means of the coolant. The rotor, on the other hand, is conveniently not pressurized with the coolant during operation, and the second chamber is free of the coolant.

Due to the design, it is therefore possible to dissipate excess heat directly from the stator by means of the coolant, so that overheating of the stator is avoided even in the event of a short-term overload of the stator. In other words, the efficiency of cooling the stator is improved, and it is possible, for example, to manufacture it from comparatively inexpensive materials. It is also possible to increase the performance of the axial flux machine. The rotor is fluidly separated from the stator and is not in contact with the coolant used to cool the stator. As a result, there are no splashing losses, which is why efficiency is increased. Furthermore, it is not necessary to introduce several cooling channels into the housing, so that on the one hand the production of the housing is simplified. On the other hand, it is possible to use a wide variety of production methods.

The housing can be made of a metal, which increases robustness. In this way, additional heat dissipation is also possible via the housing. For example, the housing is at least partially made of steel or, preferably, of aluminum. In this way, robustness is comparatively high, while weight is reduced.

The separating disc, for example, is made of a metal. In this way, robustness is increased. However, it is particularly preferable that the separating disc be made of a plastic, preferably a glass fiber reinforced material, such as glass fiber reinforced carbon. In this way, weight is reduced. Preferably, the separating disc is made of a glass fiber reinforced plastic, wherein polyamide, for example, is used as the plastic. In this way, robustness is increased, wherein the separating disc is electrically non-conductive. This makes it possible to make desired or undesirable contact with current-carrying components of the stator or rotor, while avoiding an electrical short circuit. It is particularly preferable for the separating disc to have a comparatively low thickness, i.e., a small expansion along the axis. In particular, this is between 0.5 mm and 2 mm and appropriately equal to 1 mm. As a result, the overall length of the axial flux machine along the axes is not increased or only comparatively slightly. It is particularly preferable for the rotor to have a distance of between 1 mm and 5 mm from the stator or the separating disc and preferably essentially 2 mm. In this way, an interaction of the magnetic fields acting between the rotor and the stator is magnified and thus also a nominal torque. In addition, the overall length of the axial flux machine is shortened.

For example, the housing can be designed in one piece. However, the housing is particularly preferred to have a first part and a second part, which are two separate components from each other, and which are preferably connected to each other in the assembly state, appropriately fastened. The first space is provided by means of the first part. For example, the housing includes other components necessary to form the first space. Alternatively, the first space is formed only by means of the first part. The first part is designed in the shape of a pot. The bottom of the pot is preferably arranged essentially perpendicular to the axis, and the opening of the pot-shaped first part points in the direction of the second part. For example, the separating disc is at least partially inserted into the pot-shaped first part. Preferably, however, in the assembly state, the separating disc is placed on the pot opening, so that the first part is at least partially closed by means of the separating disc. In this case, the separating disc is placed on a circumferential edge of the first part, so that it is stabilized by means of the edge. Due to the placement on the circumferential edge, the position of the separating disc is predetermined, so that assembly is simplified. For example, the separating disc is simply placed on the edge or preferably attached there, preferably by means of an adhesive. Thus, on the one hand, the integrity of the separating disc is not compromised. On the other hand, in this way the position of the separating disc is stabilized with respect to the first part and preferably fixed.

The second space can be provided by means of the second part. For example, the second space is only formed by means of the second part, or there are other components by means of which the second space is formed. The second part is hollow cylindrical, so it has a hollow cylindrical section. In particular, the second part is formed only by means of the corresponding hollow cylinder, i.e., the hollow cylindrical section. Alternatively, the second part has other components that are molded and/or attached to the hollow cylinder. The hollow cylindrical section is conveniently arranged along the axis and concentric to it.

More conveniently, the first part and the second part can be made of a metal, preferably the same metal. Thus, they do not exhibit different thermal expansion, which is why operation and construction are simplified. Particularly preferably, a bearing is held, especially fastened, on the first part, by means of which the rotor, preferably the possible shaft, is rotatably mounted. Thus, the first part also serves as a bearing shield, which is why the number of different components required for the axial flux machine are reduced. Thus, manufacturing costs and size are reduced.

For example, the separating disc can be simply placed bluntly on the circumferential edge. However, it is particularly preferable to have a sealing ring on the end face of the circumferential edge. In particular, the sealing ring is designed in the manner of an O-ring and is made of a rubber or a caoutchouc, for example. In this case, the sealing ring is at least partially arranged between the first part and the separating disc, so that it prevents a liquid from passing through between the edge and the separating disc. The sealing ring also compensates for manufacturing tolerances. For example, the sealing ring rests directly on the edge. However, it is particularly preferable to have a groove in the circumferential edge, in which it is at least partially inserted. Thus, the position of the sealing ring is stabilized, which simplifies production. Also, the overall length is reduced in the axial direction, i.e., parallel to the axis.

The second part can be in force-fit contact with the circumferential edge at the end face via the separating disc. In other words, by means of the second part, the separating disc is pressed against the circumferential edge, which improves the sealing effect. In addition, the sealing ring, if any, is at least partially elastically and/or plastically deformed in this way, which improves the sealing effect. In summary, the second part presses the separating disc to the edge, so that the position of the separating disc in particular is stabilized. Furthermore, due to the frictional contact, the second part is attached to the first part, which is why robustness is increased. In particular, the second part and the first part are attached to each other by means of one or more screws. In this way, the prevailing force for frictional connection can be set comparatively precisely, which is why damage to the separating disc and/or any sealing ring can be avoided. It is also possible to produce and check the fluid separation, i.e., the fluid-tight design, comparatively efficiently, so that rejects during production are reduced. This also simplifies disassembly, for example as part of maintenance.

For example, the first part and the second part can be flush with each other, especially in terms of their circumferences. This means that there is no edge or the like, which is why space requirements are reduced and/or the accumulation of foreign particles is avoided. However, it is particularly preferred for the second part to have a protrusion by means of which the first part is enclosed on the circumferential side. The protrusion has a greater distance to the axis than the first part, at least as compared to the edge. Consequently, the first part, in particular the edge, is partly located in the second part. Thus, on the one hand, the first part is stabilized by means of the protrusion, which is why its robustness is increased. On the other hand, the position of the two parts in relation to each other is predetermined in this way, which is why assembly is simplified.

For example, the protrusion can be partially interrupted, so that space and material requirements are reduced. However, it is particularly preferred for the protrusion to be circumferential, which increases robustness. Furthermore, due to the protrusion, a step is formed in the end area of the second part, so that in particular there is a simplified labyrinth seal, which is why tightness is further increased. Preferably, between the first part and the protrusion, there is another sealing ring, which surrounds the first part in particular on the outside, and which is enclosed by means of the protrusion. As a result, tightness is further increased and any manufacturing tolerances are compensated.

For example, the protrusion can be intact. Particularly preferably, the protrusion has an opening that runs, in particular, in the radial direction, i.e., perpendicular to the axis, and which ends in an opening in the first part. This opening extends into the first space, and any sensing fluid is fed into and/or out of the first space via the openings during operation.

For example, the bottom of the pot-shaped first part can be circular and formed by means of an essentially flat surface. This simplifies production. However, it is particularly preferred for the first part to have a collar arranged concentrically to the axis, which is designed circumferentially and is arranged inside the stator. The end of the collar and the edge of the first part are preferably in a common plane perpendicular to the axis. By means of the collar, the first space is delimited on the inside, and the first space and also the bottom of the pot are thus ring-shaped. The separating disc is conveniently placed on the end face of the collar. This prevents the passage of a liquid there as well. Preferably, the separating disc is also ring-shaped, which reduces the space required. In particular, the circumference of the possible shaft is surrounded by the separating disc.

A fastening ring can be disposed in the second space, which is conveniently made of a metal, such as steel. The fastening ring can be attached to the collar, for example directly or via other components. The separating disc is conveniently held friction-locked between the collar and the fastening ring. Consequently, the separating disc is pressed against the collar by means of the fastening ring, so that tightness is improved there. In particular, the fastening ring is attached to the collar by means of one or more screws, so that the force acting on the separating disc can be set comparatively precisely. In particular, the screws are arranged in such a way that they do not protrude through the separating disc, which is why the mechanical integrity of the latter is not affected. It is particularly preferable to place a seal, in particular a sealing ring, on the end face of the collar, which is made of rubber or caoutchouc, for example. This is at least partially elastically and/or plastically deformed, especially due to the acting force, so that tightness is further improved.

The stator can include the sheet metal package, which can be ring-shaped, and which is conveniently arranged concentrically to the axis. In particular, the individual sheets are arranged in a ring-shaped and concentric manner in relation to each other. The sheet metal package itself rests on the end face, i.e., at its end in the axial direction, i.e., parallel to the axis, on the one hand against the separating disc and on the other hand against the housing. In other words, the sheet metal package is thus disposed, preferably held, between the housing, in particular the bottom of the pot of the first part, if any, and the separating disc. In this way, the sheet metal package is stabilized by means of the housing, so that robustness is increased. In addition, the separating disc is stabilized by means of the stator. Thus, robustness is also increased there.

The arrangement of the sheet metal package can be such that the first space is divided into a first subspace surrounding the sheet metal package and a second subspace within the sheet metal package. The second subspace has a smaller distance to the axis than the first subspace. Consequently, the first subspace surrounds the second subspace, wherein a distance is formed between them, which is given by means of the sheet metal package. In particular, due to the attachment of the sheet metal package to the housing, the passage of coolant between the housing and the assigned end face of the sheet metal package is avoided. Conveniently, passage of the coolant between the sheet metal package and the separating disc on the other end face of the sheet metal package is also avoided.

The first subspace and the second subspace can be fluidly connected to each other by means of several cooling channels that protrude through the sheet metal package. Preferably, the axial flux machine has an inlet and an outlet, one of which is assigned to the first subspace and the other to the second subspace. In particular, they run through the housing into the respective subspace. During operation, the cooling fluid is introduced into one of the subspaces and from there through the sheet metal package to the other subspace and from there out of the housing. In particular, the inlet and outlet each form a connection to the possible cooling circuit. Thus, during operation, the sheet metal package is pressurized with the coolant on the outside and inside, as well as on the inside due to the cooling channels, which is why comparatively efficient cooling of the sheet metal package takes place.

For example, there may only be one or two such cooling channels. Thus, the space requirement is comparatively low. It is particularly preferable for each cooling channel to merge into a stator groove of the sheet metal package, wherein an electrical coil of a respective electromagnet is at least partially embedded in each stator groove. This reduces the effort required to provide the cooling channels. In addition, additional space requirements are reduced and production is simplified. Furthermore, due to the cooling channels, it is easier to arrange the respective electrode of the electrical coil/winding in the stator groove. Also, when operated by means of the part of the portion of coolant passed through the respective cooling channel, the respective electrical coil is at least partially cooled. In particular, the axial flux machine has between 25 and 30 such cooling channels and thus also stator grooves. Preferably, the number of cooling channels and therefore also the number of electrical coils is equal to 27. In this way, a comparatively constant torque can be achieved during operation, which reduces effort.

For example, the axial flux machine may only have one stator. Particularly preferably, the axial flux machine includes a second stator, which is designed ring-shaped. The second stator surrounds the axis and is preferably concentric to it. The second stator is offset to the rotor parallel to the axis, wherein the rotor is located between the two stators. In particular, the two stators are arranged congruently. The second stator is suitably identical to the stator. During operation, the rotor interacts with each of the two stators, so that the forces acting on the rotor are increased. For example, the axial flux machine also includes a second rotor that interacts with the second stator, for example. However, only the single rotor is particularly preferred, which is why the overall length of the axial flux machine is shortened. In summary, the second stator increases the power provided by the axial flux machine, with only a single rotor, so that the axial length is not excessively increased.

Conveniently, the second stator can be arranged in a third space of the housing, wherein the second space and the third space are separated from each other by means of a second separating disc and are separated from each other in terms of fluid technology. In particular, the separating discs are identical to each other, and/or the third space is identical to the first space. In particular, the axial flux machine is a mirror image or at least symmetrical with respect to the rotor, so that a comparatively large number of common parts can be used. This also makes it easier to replace them and reduces the number of spare parts that need to be stocked. Appropriately, the third space is provided by means of a third part of the housing, by means of which a bearing is preferably held, by means of which the possible shaft is rotatably mounted. In particular, the first and third parts each form a bearing shield of the housing.

For example, the motor vehicle can be land bound or airworthy. However, it is particularly preferred for the motor vehicle to be sea bound, for example a ship or boat. The motor vehicle has a main drive system which serves to propel the motor vehicle. The main drive comprises a liquid-cooled axial flux machine, which comprises a rotatable rotor and a ring-shaped stator arranged around the axis, which are offset from each other parallel to the axis. The stator is located in a first space of a housing and the rotor in a second space of the housing, which are bounded by a separating disc and fluidically separated from each other.

In addition, the vehicle can have a cooling circuit that is fluidically connected to the first space. In particular, the cooling circuit includes several pipes, at least two of which are fluidically connected to the first space. During operation, coolant is routed via the pipes into and out of the first space, so that heat is removed from the first space by means of the coolant. Preferably, the cooling circuit has a pump by means of which the coolant is pumped. Preferably, the cooling circuit (coolant circuit) has a heat exchanger that is pressurized, for example, with ambient air or water, such as sea or river water. This makes it possible to cool down the heated coolant.

The further developments and advantages explained in connection with the liquid-cooled axial flux machine can also be transferred mutatis mutandis to the motor vehicle and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows, in a side view, schematically a motor vehicle with a main drive system comprising a liquid-cooled axial flux machine,

FIG. 2 shows, in perspective, the axial flux machine, which has a housing with a first, second and third part,

FIG. 3 shows, in a sectional representation along an axis, the axial flux machine,

FIG. 4 shows, in perspective, the axial flux machine,

FIGS. 5, 6 show, in perspective, a sheet metal package of a stator of the axial flux machine,

FIG. 7 shows, in perspective, the axial flux machine,

FIG. 8 shows, an enlarged section of the sectional representation as shown in FIG. 3, and

FIGS. 9 and 10 show, in perspective or excerpts in a sectional representation, a further example of the first part.

### DETAILED DESCRIPTION

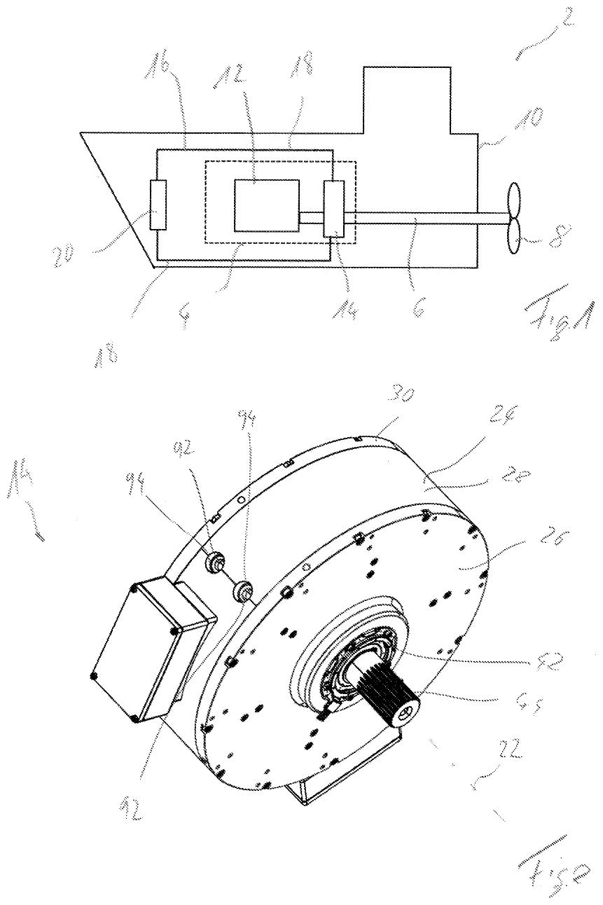

FIG. 1 schematically shows a side view of a motor vehicle 2 in the form of a ship. The motor vehicle 2 has a main drive system 4, by means of which a ship's shaft 6 is driven, to which a propeller 8 is attached at the end. In this case, the propeller 8 is located outside a cover 10 of the motor vehicle 2, through which the ship's shaft 6 is guided. With the exception of the propeller 8 and the part of the ship's shaft 6 protruding through the cover 10, the components of the motor vehicle 2 are surrounded by the cover 10. Consequently, the main drive 4 is also surrounded by the cover 10.

The main drive system 4 has an internal combustion engine 12, by means of which the ship's shaft 6 is driven by a gearbox. In addition, the main drive 4 comprises an axial flux machine 14, which also acts on the shaft 6. By means of the axial flux machine 14, which is designed as an electric motor, a nominal power of 200 KW and a nominal torque of 1200 Nm are provided. Thus, it is possible to rotate the ship's shaft 6 by means of the internal combustion engine 12 alone, by means of the axial flux machine 14 alone or by means of both, so that the motor vehicle 2 is propelled by water. For example, when maneuvering in a port, only the axial flux engine 14 is used to drive the ship's shaft 6, so that environmental pollution near the port is reduced.

The vehicle 2 also has a cooling circuit 16 which has several pipes 18 which are fluidically coupled to the axial flux machine 14. The cooling circuit 16 also includes an unspecified pump and a heat exchanger 20 which is supplied with the water surrounding the cover 10. During operation, a coolant, i.e., oil, is pumped through the pipes 18 by means of the pump, so that it flows through the axial flux machine 14 and is heated by a heat loss present there. The heated coolant is passed through another of the pipes 18 to the heat exchanger 20, where the coolant is cooled. Subsequently, the cooled coolant is fed back to the axial flux machine 14. Consequently, the axial flux machine 14 is a liquid-cooled axial flux machine.

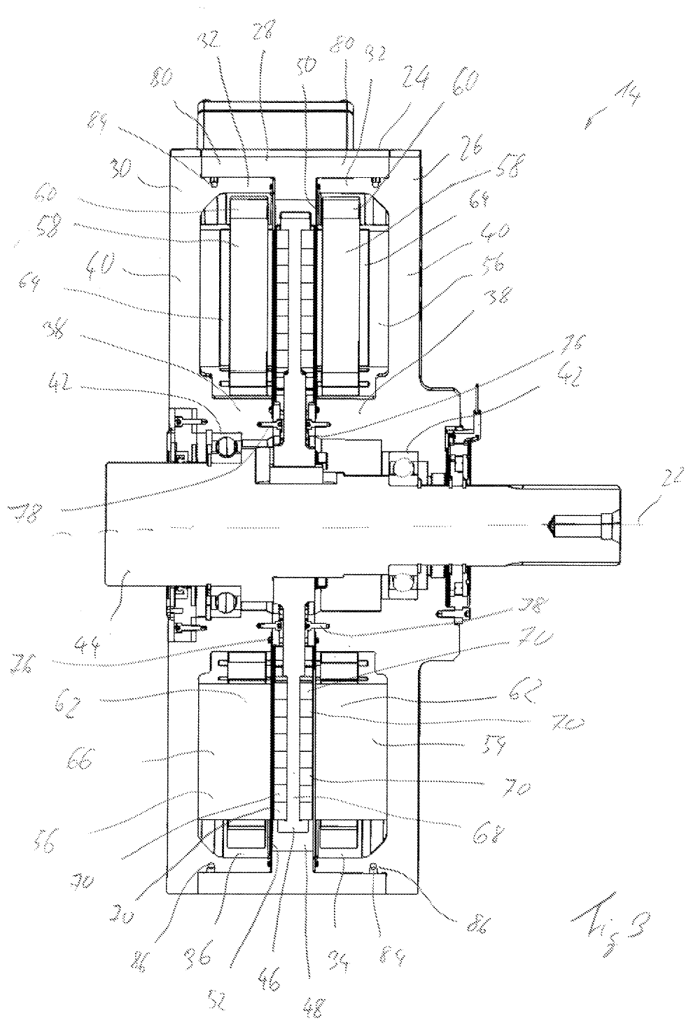

In FIG. 2, the axial flux machine 14 is in perspective and in FIG. 3 in a sectional representation along an axis 22. The axial flux machine 14 has a housing 24, which comprises a first part 26, a second part 28 and a third part 30. The three parts 26, 28, 30 are made of aluminum.

The first part 26 and the third part 30 are each designed in the shape of a pot, so that they each have a circumferential edge 32, by means of which a first space 34 and a third space 36 are surrounded on the circumferential side. The edges 32 are hollow cylindrical and arranged concentrically to the axis 22, wherein the two edges 32 have the same round diameter perpendicular to the axis 22.

In addition, the first part 26 and the third part 30 each have a hollow cylindrical collar 38, each of which is arranged concentrically to axis 22 and both of which have the same radius. In this case, the distance of the collars 38 to the axis 22 is less than the distance of the edges 32 to the axis 22. The collars 38 bound the first space 34 or the third space 36 on the inside. The collars 38 and the edges 32 each have the same expansion in the axial direction, i.e., parallel to the axis 22, and are each connected to a pot bottom 40 of the respective pot-shaped first part 26 or third part 30, so that each of the two parts 26, 30 has an opening directed in the axial direction, with the openings facing each other. Consequently, the two pot bottoms 40 essentially form the ends of the housing 24 in the axial direction, i.e., parallel to the axis. In summary, each collar 38 and the respective edge 32 of the two parts 26, 30 end in the same plane perpendicular to the axis 22.

Within each collar 38 a bearing 42 is inserted and held there. The two bearings 42 are rolling bearings, namely ball bearings, and by means of them a shaft 44 arranged concentrically and along axis 22 is rotatably mounted around axis 22. A rotor 46 is torsionally fixed to the shaft 44, which is arranged in a second space 48. The second space 48 is located in the axial direction, i.e., parallel to the axis 22, between the first space 34 and the third space 36 and is provided by the second part 28 of the housing 24. The second part 28 has a hollow cylindrical design and is arranged concentrically to the axis 22. In addition, the second part 28 is attached to the first part 26 and the third part 30, with the second part 28 closed at the end by means of these.

The second space 48 is separated from the first space 34 by a ring-shaped separating disc 50 and from the third space 36 by a second separating disc 52. In other words, the second space 48 is bounded at both ends in the axial direction by one of the separating discs 50, 52 each. The first space 34 is bounded in the axial direction by means of the separating disc 50 on the end opposite the pot bottom 40 of the first part 26. The third space 36 is bounded on the opposite side of the pot bottom 40 of the third part 30 in the axial direction by means of the second separating disc 52. By means of the two separating discs 50, 52, a fluid power separation of the thus limited three spaces 34, 36, 48 is carried out. The two separating discs 50, 52 are identical to each other and are made of a glass fiber reinforced polyamide. The two separating discs are arranged perpendicular to the axis 22, and the thickness of each separating disc 50, 52, i.e., its expansion parallel to axis 22, i.e., its thickness, is 1 mm.

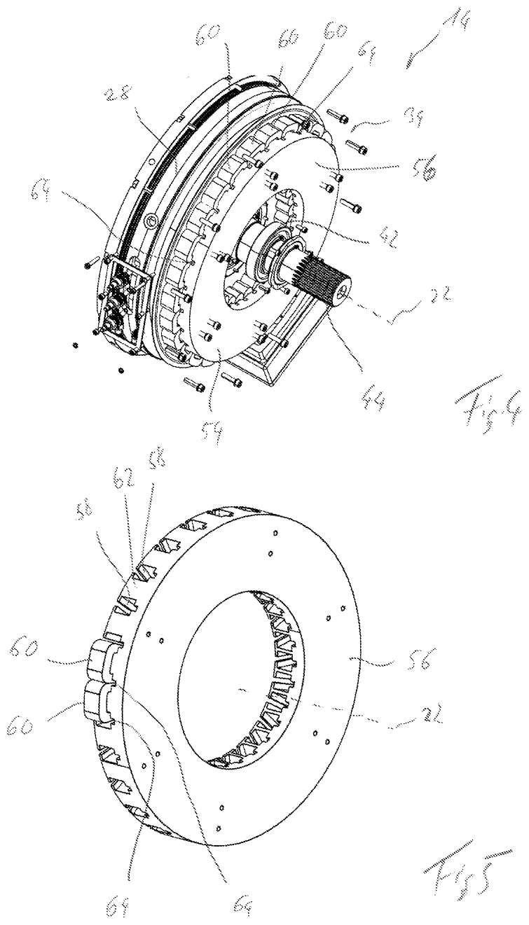

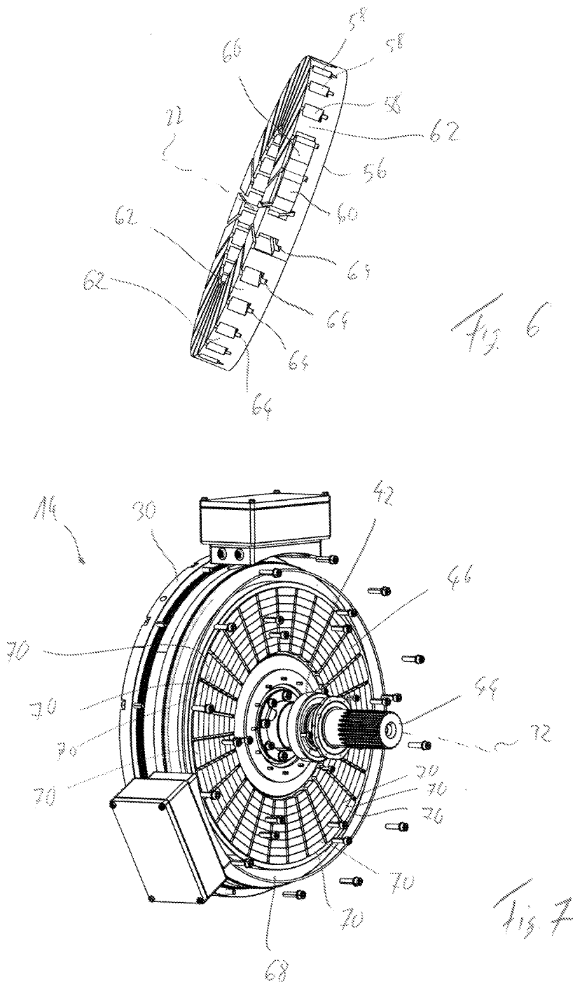

FIG. 4 shows the axial flux machine 14 without the first part 26, so that the first space 34 is visible. Within the first space 34 is a ring-shaped stator 54, which is arranged concentrically to the axis 22. The stator 54 has a ring-shaped sheet metal package 56, which is shown from different perspectives in FIGS. 5 and 6. The sheet metal package 56 comprises several unspecified sheet metal layers, which are arranged concentrically and each surround each other on the circumference. A total of 27 stator grooves 58 are routed through the sheet metal package 56, which run in a radial direction with respect to the axis 22. In other words, each of the stator grooves 58 is arranged along a straight line that intersects the axis 22 at an angle of 90°, with all the lines arranged in a common plane perpendicular to the axis 22.

Each of the stator grooves 58 contains two different electrical coils 60, of which only two are shown in FIGS. 5 and 6, each of which is made of an enameled copper wire. Each electrical coil 60 is wound around a tooth 62 of the sheet metal package formed between two of the stator grooves 58. Therefore, there are 27 such electrical coils 60.

The sheet metal package 56 also has 27 cooling channels 64, each of which is assigned to one of the stator grooves 58. Each cooling channel 64 runs in the radial direction and connects to the respective stator grooves 58 in the axial direction, so that each cooling channel 64 merges into one of the stator grooves 58 of the sheet metal package 56. In this case, the cooling channels 64 are located on the side of the respective stator groove 58 facing the bottom of the pot 40 of the first part 26. The expansion of the cooling channels 64 in the tangential direction with respect to the axis 22 is less than that of the stator grooves 58, and the cooling channels 64 are free of the electrical coils 60.

In the third space 36 a second stator 66 is arranged, which is identical to the stator 54 and is a mirror image of a plane perpendicular to the axis 22. For example, the second stator 66 also has the sheet metal package 56 with the 27 electrical coils 60 and the assigned stator grooves 58 and teeth 62 as well as the cooling channels 64. In this case, the cooling channels 64 are arranged on the side of the respective stator grooves 58 facing the bottom of the pot 40 of the third part 30. Due to the arrangement in the third space 36, the two stators 54, 66 are thus offset from each other parallel to the axis 22, with the rotor 46 between them, which is offset to the stator 54 and the second stator 66 parallel to the axis 22.

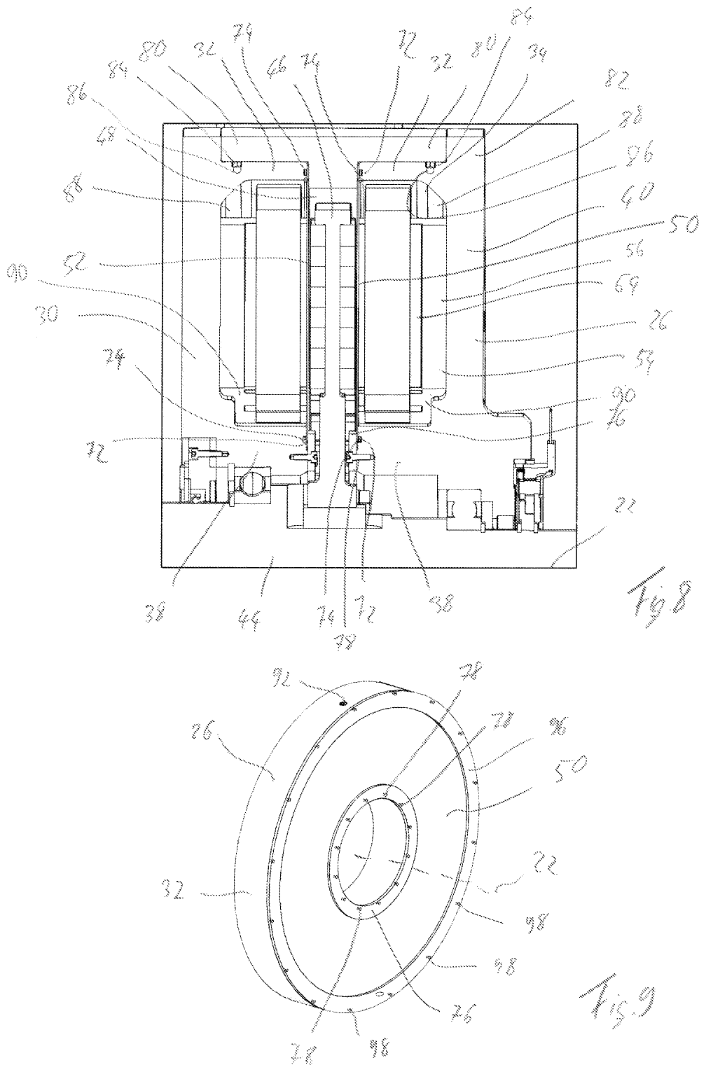

FIG. 7 shows the axial flux machine 14 in perspective, wherein the stator 54 and the first part 26 are not shown, so that the rotor 46 is visible. The rotor 46 has a sheet metal package 68, which is torsionally fixed to the shaft 44. By means of the sheet metal package 68 of the rotor 46, several permanent magnets 70 are held, the magnetization direction of which is parallel to the axis 22. When the electric coils 60 of the two stators 54, 66 are energized, the magnetic fields created by them interact with the magnetic fields created by the permanent magnets 70, so that the rotor 46 is rotated with respect to the stators 54, 66, which are permanently attached to the housing 24. As a result, the shaft 44 is also put into a rotational motion around the axis 22.

In summary, the axial flux machine 14 thus has the rotatable rotor 46 rotating around the axis 22 and the ring-shaped stators 54, 66 arranged around the axis 22, each of which is offset to each other parallel to the axis 22. In this case, rotor 46 is located between the two stators 54, 66 in the axial direction. The stator 54 is located in the first space 34 of the housing 24, the rotor 46 in the second space 48 of the housing 24 and the second stator 66 in the third space 36 of the housing 24. In this case, the first space 34 and the second space 48 are bounded by means of the separating disc 50 and are fluidically separated from each other. The second space 48 and the third space 36 are fluidically separated from each other by means of the second separating disc 52.

As shown in part in FIG. 8 in an enlarged sectional representation, the separating disc 50 is placed on the end face of the circumferential edge 32 of the first part 26 and glued to it. Also, the ring-shaped separating disc 50 is placed on the end face, i.e., the part of the collar 38 facing away from the bottom of the pot 40 and glued there to it. A groove 72 is inserted into the end face of the circumferential edge 32 and the collar 38, which is ring-shaped and whose opening is turned away from the bottom of the pot 40. Within each groove 72 there is a sealing ring 74, which is designed in the form of an O-ring and made of rubber. The sealing ring 74 assigned to the collar 38 and the assigned groove 72 have a reduced radius as compared to the sealing ring 74 assigned to the edge 32 and the corresponding groove 72. Otherwise, however, they are identical to each other. To sum up, therefore, the sealing ring 74 rests on the circumferential edge 32 and the separating disc 50 is placed on the circumferential edge 32 of the first part 26.

In the second space 48 there is a fastening ring 76, which is made of a steel and whose outer radius is greater than the radius of the sealing ring 74 and whose inner radius is smaller than the radius of the sealing ring 74. The fastening ring 76 is attached to the collar 38 by means of several fastening screws 78, wherein the fastening screws 78 are essentially parallel to the axis 22 and screwed through the fastening ring 76 into the collar 38. The fastening screws 78 are not passed through the separating disc 50, and therefore have a smaller distance to the axis 22 than the inner diameter of the separating disc 50.

By means of the fastening screws 78, the separating disc 50 is held frictionally in place between the collar 38 and the fastening ring 76. Thus, the first space 34 is fluidically separated from the second space 48 on the inside, and even in the event of a load, the separating disc 50 is prevented from detaching from the collar 38. Consequently, robustness is increased. In summary, the first part 26 has the collar 38 circumferential within the stator 54 and arranged concentrically to the axis 22, by means of which the first space 34 is bounded on the inside, wherein in the second space 48 the fastening ring 76 is arranged, which is attached to the collar 38 by means of the fastening screws 78, wherein the separating disc 50 is frictionally held between the collar 38 and the fastening ring 74.

On the radial outer side, the second part 28 rests force-fit over the separating disc 50 on the circumferential edge 32, so that the second part 28 prevents the separating disc 50 from detaching from the edge 32. In addition, the second part 28 has a protrusion 80, by means of which the circumferential edge 32 of the first part 26 is circumferentially enclosed. Thus, the second part 28 partially encompasses the circumferential side of the first part 26 by means of the protrusion 80, which is designed in the form of a hollow cylinder and which rests on the end face of an appendage 82 of the first part 26, which lies in a plane with the bottom of the pot 40 of the first part 26 and protrudes radially over the edge 32. Thus, a labyrinth seal is formed between the first part 26 and the second part 28. In addition, an additional groove 84 is inserted into the circumferential edge 32, within which another sealing ring 86 is inserted. Thus, tightness is further improved.

The second separating disc 52 is attached to the third part 30 in the same way as the separating disc 50 is attached to the first part 26. Thus, the third part 30 also has the grooves 72, in which corresponding sealing rings 74 are inserted. There is also the additional groove 84 and the additional sealing ring 86, which is arranged between a corresponding protrusion 80 of the third part 30 and the corresponding circumferential edge 32. Consequently, the second part 28 has two such protrusions 80, one of which encompasses the circumferential edge 32 of the third part 30. The second separating disc 52 is also held in a frictional fit by means of a corresponding fastening ring 76 on the collar 38 of the third part 30.

The sheet metal package 56 of the stator 54 rests with one of its end faces against the bottom of the pot 40 of the first part 26 and is fixed there. The other end face rests against the separating disc 50 and is attached to it. Thus, the separating disc 50 is stabilized by means of the sheet metal package 56, wherein the stabilization of the sheet stack 56 is carried out by means of the first part 26. As a result of this fit, the first space 36 is divided into a first subspace 88 surrounding the sheet metal package 56 and a second subspace 90 surrounded by the sheet metal package 56, which is thus located within the sheet metal package 56. The fluid power connection between the two subspaces 88, 90, which are arranged concentrically to the axis 22, and between which the sheet metal package 56 is arranged in the radial direction, is carried out by means of the cooling channels 64 which run through the sheet metal package 56. The second stator 66 is attached in the same way to the third part 30 and the second separating disc 52 and is arranged accordingly in the third space 36, so that a first subspace 88 and a second subspace 90 are also formed there.

Each first subspace 88 is fluidically connected to one of the pipes 18 of the cooling circuit 16 by means of an opening 92 inserted into the respective assigned edge 32 and a corresponding aligned opening 94 of the corresponding protrusion 80 of the second part 28, so that by means of the two openings 92, 94 an inflow to the first space 34 or the second space 36 is formed. The two second subspaces 90 are fluidically connected to another of the pipes 18 of the cooling circuit 16 by means of unspecified openings.

When the electric coils 60 of the stators 54, 66 are energized, electrical losses occur, which lead to a heating of them. By means of the coolant flowing in through openings 92, 94, the two stators 54, 66 are each circumferentially flushed and consequently cooled there by means of the coolant. The coolant is conveyed via the cooling channels 64 to the respective second subspace 90, so that the sheet metal package 56 as well as the electrical coils 60 are cooled by means of the coolant. As soon as the coolant has arrived in the second subspace 90, the respective stator 54, 66 is also flushed by it and partially cooled there. The heated coolant is then fed through the openings to the corresponding pipe 18 and from there to the heat exchanger 20. Consequently, a comparatively large surface area of the respective stator 54, 66 is pressurized by means of the coolant, so that comparatively effective cooling takes place, wherein the coolant does not pass into the second space 48. As a result, there are no splashing losses when the rotor 46 is rotated, which is why the efficiency of the axial flux machine 14 is not reduced.

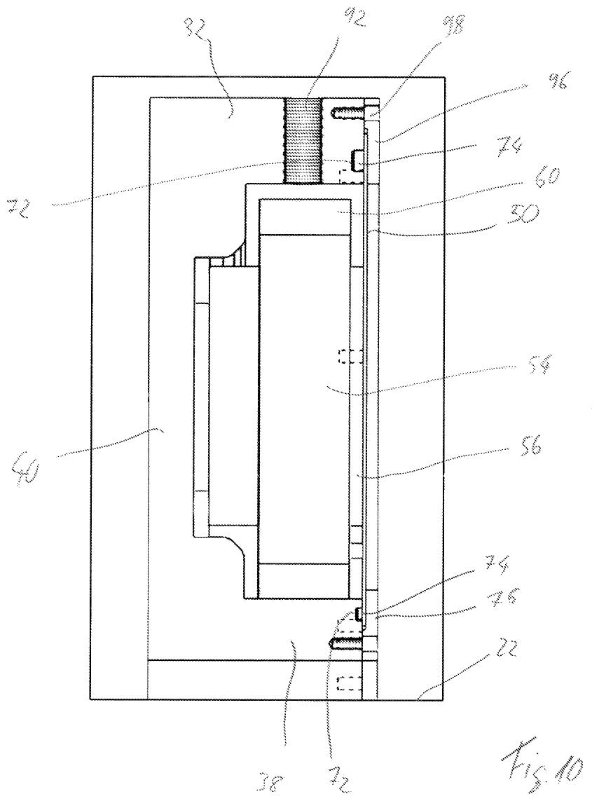

FIG. 9 and FIG. 10 show, in a cross-sectional representation along axis 22, an alternative form of design of the first part 26. In this case, the edge 32 forms the circumferential boundary of the first part 26. In other words, in this design of the axial flux machine 14, the protrusion 80 of the second part 28 is not necessary and does not exist. The separating disc 50 has not been changed, and the collar 38 is still present, to which the separating disc 50 is frictionally held in place by means of the unchanged fastening ring 76. Here, too, the fastening screws 78 are present, by means of which the fastening ring 76 is screwed to the collar 38. In this design, too, the separating disc 50 rests on both the collar 38 and the edge 32 via the sealing rings 74, which are arranged in the corresponding grooves 72, and is glued to their end faces.

There is another fastening ring 96 arranged perpendicular to the axis 22, the outer diameter of which corresponds to the outer diameter of the edge 32 and the inner diameter of which corresponds to inner diameter of the edge 32. The additional fastening ring 96 is made of the same material as the fastening ring 76 and is screwed to the edge 32 by means of additional fastening screws 98, wherein the other fastening screws 98 are essentially parallel to the axis 22 and extend through the additional fastening ring 96. The separating disc 50 is frictionally held in place by means of the other fastening screws 98 between the additional fastening ring 96 and the end face of the edge 32.

The sheet metal package 56 of the stator 54 rests on the separating disc 50 and is spaced from the bottom of the pot 40. Also, the cooling channels 64 are not present. During operation, the coolant entering through the opening 92 thus also flushes around the sheet metal package 56 on one of the end faces, so that comparatively effective cooling takes place there. However, there is no cooling of the inside of the sheet metal package 56 as in the previous design. With this design, it is possible to produce the first part 26 with the separating disc 50 attached to it and the enclosed stator 54 as a module.

The invention is not limited to the embodiments described above. On the contrary, other variants of the invention can also be derived from it by the skilled person without leaving the subject matter of the invention. In particular, all the individual features described in connection with the individual embodiments can also be combined with each other in other ways without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A liquid-cooled axial flux machine comprising:
a rotating rotor; and
a ring-shaped stator arranged around an axis, the rotating rotor and the ring-shaped stator being arranged offset from each other substantially parallel to the axis,
wherein the stator is arranged in a first space of a housing and the rotor is arranged in a second space of the housing, the first and second space being bounded by a separating disc and fluidically separated from each other.

2. The liquid-cooled axial flux machine according to claim 1, wherein the housing has a pot-shaped first part via which the first space is provided and a hollow cylindrical second part via which the second space is provided, and wherein the separating disc is placed on an end face on a circumferential edge of the first part.

3. The liquid-cooled axial flux machine according to claim 2, wherein a sealing ring is attached to the circumferential edge on the end face.

4. The liquid-cooled axial flux machine according to claim 2, wherein the second part frictionally rests on the end face of the circumferential edge via the separating disc.

5. The liquid-cooled axial flux machine according to claim 2, wherein the second part encompasses the first part on the circumferential side via a protrusion.

6. The liquid-cooled axial flux machine according to claim 2, wherein the first part has a collar circumferential within the stator and arranged concentrically to the axis, via which the first space is bounded on an inside, wherein a fastening ring is arranged in the second space attached to the collar, and wherein the separating disc is frictionally held between the collar and the fastening ring.

7. The liquid-cooled axial flux machine according to claim 1, wherein the stator has a ring-shaped sheet metal package arranged around the axis, which rests on an end face against the separating disc and rests against the housing such that the first space is divided into a first subspace surrounding the sheet metal package and a second subspace within the sheet metal package, and wherein the subspaces are fluidically connected to each other via cooling channels running through the sheet metal package.

8. The liquid-cooled axial flux machine according to claim 7, wherein each cooling channel merges into a stator groove of the sheet metal package.

9. The liquid-cooled axial flux machine according to claim 1, further comprising a ring-shaped second stator arranged around the axis and offset from the rotor that is substantially parallel to the axis, wherein the rotor is located between the two stators, wherein the second stator is arranged in a third space of the housing, and wherein the second space and the third space are bounded and fluidically separated from each other via a second separating disc.

10. A motor vehicle comprising:
a main drive comprising a liquid-cooled axial flux machine according to claim 1; and
a cooling circuit fluidically connected to the first space.
